(19) United States
(12) Patent Application Publication
(10) Pub. No.: US 2011/0276590 A1
(43) Pub. Date: Nov. 10, 2011

(54) METHOD AND SYSTEM FOR PROCESSING DATA

(76) Inventors: John Shane Hayes, Dublin (IE); Ian Anthony Pepper, Dublin (IE)

(21) Appl. No.: 13/103,370

(22) Filed: May 9, 2011

(30) Foreign Application Priority Data
May 10, 2010 (IE) S2010/0285
Apr. 21, 2011 (IE) S2011/0195

(51) Int. Cl. G06F 17/30

(52) U.S. Cl. 707/769; 707/E17.014

(57) ABSTRACT

A method, system and computer program for protecting a user from email and electronic content overload and assisting the user with processing and sorting electronic data by employing intermediate email addresses. The intermediate email addresses can be a user-specific intermediate email address generated in response to the user signing up to the system or a system-specific email address peculiar to the class of email messages to be sorted by the system to which the user can forward emails received at the user's private email address for processing and sorting.

### INTRODUCTION

This invention relates to a method and system for processing data and in particular to a method and system for sorting email messages and electronic content between senders and recipients.

### BACKGROUND OF THE INVENTION

Information overload such as email and associated electronic content overload is a significant and increasing problem for businesses and individuals. Email and electronic content overload is distinct from email spam—email and electronic content overload refers to the increasingly common situation in which a recipient receives an excessive amount of desired data. Conversely, email spamming refers to the situation in which a recipient receives undesired emails.

Email spamming has been addressed by the use of spam filters such as those available from Google (Trade Mark), Microsoft (Trade Mark), Yahoo (Trade Mark) and the like. Email spamming has also been addressed through the use of methods employing disposable email addresses such as the methods and systems described in U.S. Pat. Nos. 7,237,010, 7,305,445 and 7,558,829.

However, information overload via email, albeit desired information, remains a problem for individuals and companies alike and is likely to increase in the future.

An example of an area in which information overload is presenting increasing problems to individuals and companies is newsletter subscriptions in which a recipient can receive multiple daily emails from subscriber news websites which in turn can contain multiple links to websites. Often these email newsletters contain digests of a news article together with links to an underlying webpage where the full article can be seen.

The advent of subscriber daily deal or coupon sites from which a plurality of emails are sent to subscribers to inform them of deals in their area or country has further compounded the problem of email overload. For example, larger cities can have in excess of 100 such websites so that if a user were to subscribe to each site, in excess of 100 emails could be sent to the user daily. As indicated above, the user may also have to process the deal information e.g. to record which deals have been purchased, expiration dates etc. which gives rise to excessive data processing requirements.

Information overload can also arise as result of a user performing online searches and purchases where a product or service is sourced on a website using a search engine but user queries can only be answered and the product or service can only be purchased if the user provides an email address to the website from which the product or service is being sold. For example, currently an accommodation seeker seeking to rent a holiday home uses a combination of Internet search engines and holiday rental accommodation websites to identify properties. Once identified, communication between the accommodation seeker and a holiday home owner moves to email which can lead to email overload where the accommodation seeker has contacted multiple holiday home owners. Similarly, a holiday home owner can receive multiple email enquiries from multiple holiday home seekers giving rise to further information overload.

Email and electronic data overload of the types described above gives rise to many problems. The necessity of reviewing and processing large amounts of emails can be time-consuming and frustrating. Moreover, receipt and review of excessive numbers of, albeit desired, emails by employees is time-consuming and wasteful giving rise to corporate inefficiencies and increased costs. In addition, increasing numbers of employees and individuals use portable wireless devices such as smartphones to send and receive emails. Wireless connectivity is generally sold by service providers in time or memory units e.g. megabytes. Accordingly, recipients who download large volumes of emails which can include large file attachments and/or links can incur significant usage charges.

### SUMMARY OF THE INVENTION

According to the invention there is provided a method for sorting classes of email messages requested by a user comprising:
receiving the user's email messages at an intermediate email address within an email sorting system;
parsing the received email messages to extract data from the emails;
storing the extracted data in an information database;
comparing the extracted data with stored data in the information database;
retrieving stored data from the information database relevant to the email message, and
autopopulating a record with the extracted data and the retrieved stored data.

Preferably, the method further comprises summarizing the extracted data and the retrieved stored data and emailing the summarized extracted data and retrieved data to the user and displaying the extracted data and the stored data on a graphical user interface accessible to the user.

Advantageously, the graphical user interface comprises a dashboard accessible to the user.

In one embodiment, the intermediate email address comprises a user-specific intermediate email address generated in response to the user signing up to the email sorting system and the user-specific intermediate email address is stored in an intermediate email address database of the email sorting system.

In an alternative embodiment, the intermediate email address comprises an email sorting system-specific intermediate email address peculiar to the class of email messages to be sorted by the email sorting system. Suitably, the email message to be sorted is forwarded to the email sorting system-specific intermediate email address by the user.

In this embodiment a user-specific email address can also be generated for the user upon receipt of the email message to be sorted.

The class of email messages to be sorted can comprise coupon containing email messages from an external website subscribed to by the user. In this embodiment, the information database comprises a database of coupon website source email addresses, a database of known deals with associated coupons and a database of deals and associated coupons purchased by the user. The coupon containing email message address is compared with the database of coupon website source email addresses to identify the coupon containing email message while the internet is continuously searched to locate new deals and associated coupons and any new deals and associated coupons are stored in a record in the database of known deals and associated coupons.

The coupon containing email message is matched with known deals and associated coupons in the database of known deals and associated coupons. In the present embodiment, the method also extends to reading characters from the coupon into memory, creating a coupon description from the characters, pattern matching the created coupon description with the database of known deals and associated coupons and creating a record of any matches in the purchased deal and coupon database.

In another embodiment of the invention, the class of email messages comprises email messages between a vacation accommodation seeker and a vacation accommodation host or website. In this embodiment of the invention, the information database comprises an email template database, a property database and a stored emails database.

In an alternative embodiment of the invention, the class of email messages comprises email newsletters containing news digests and the information database comprises a source email address database and a user's email subscription database.

In the present embodiment, the method of sorting the email messages comprises parsing the received news digests, storing the news digests in the information database, extracting heading tags from the news digests, storing the heading tags in the information database with the news digests, identifying links to external websites in the email newsletters, storing the links to the external websites in the information database, crawling the external websites, extracting data from the crawled websites and storing the data extracted from the external websites in the information database and subjecting the stored data to a relevance algorithm to rank the data according to the user's preferences.

Advantageously, the stored data subjected to the relevance algorithm comprises meta tags and the meta tag data comprises meta tags generated by the author of the data. Suitably, the relevance algorithm attributes a meta tag interest score to the meta tags in accordance with the user's interests.

The method further comprises normalising the meta tag interest score according to a time period and compensating the normalised meta tag interest score according to the frequency with which the user follows the link for a news digest to an external website.

In a preferred embodiment of the invention, the user's preferences are automatically updated by the relevance algorithm according to usage by the user and the updated user's preferences are stored in a user preferences database.

The invention also extends to a system for sorting classes of email messages requested by a user comprising:
means for receiving the user's email messages at an intermediate email address within an email sorting system;
an email parser for parsing the received email messages to extract data from the emails;
an information database for storing the extracted data;
means for comparing the extracted data with stored data in the information database;
means for retrieving stored data from the information database relevant to the email message, and
means for autopopulating a record with the extracted data and the retrieved stored data.

Preferably, the system further comprises a graphical user interface for displaying the extracted data and the stored data. More preferably, the graphical user interface comprises a dashboard for displaying the autopopulated record for the use. Suitably, the system comprises an information summariser for summarising the information.

In a preferred embodiment of the invention the system further comprises means for continuously determining the user's information preferences to autopopulate the record in accordance with the user's preferences.

The invention also provides a method for sorting classes of email messages requested by a user comprising:
receiving the user's email messages within an email sorting system;
parsing the received email messages to extract data from the emails;
storing the extracted data in an information database;
comparing the extracted data with stored data in the information database;
retrieving stored data from the information database relevant to the email message, and
autopopulating a record with the extracted data and the retrieved stored data.

In a further embodiment, the invention also extends to a computer program product comprising computer executable instructions for performing a method of sorting classes of email messages requested by a user, the method comprising:
receiving the user's email messages at an intermediate email address within an email sorting system;
parsing the received email messages to extract data from the emails;
storing the extracted data in an information database;
comparing the extracted data with stored data in the information database;
retrieving stored data from the information database relevant to the email message, and
autopopulating a record with the extracted data and the retrieved stored data.

The method and system of the invention protects a user from email and electronic content overload and assists the user with processing and sorting electronic data by employing intermediate email addresses. The intermediate email addresses can be a user-specific intermediate email address generated in response to the user signing up to the email sorting system or a system-specific email address peculiar to the class of email messages to be sorted by the email sorting system to which the user can forward emails received at the user's private email address for processing and sorting.

The user can provide their user-specific intermediate email address as required to external websites such as news websites, vacation websites, coupon or deal websites and the like from which the user wishes to receive email communications. Emails to the user-specific intermediate email address are received by the system of the invention, the electronic content of the received emails is assessed and the information relevant to the user is extracted from the email and any websites linked to the email, summarised and presented to the user either by email or on a dashboard accessible to the user.

Accordingly, the user is not presented with large numbers of emails for review and the information is condensed thereby reducing download time and cost.

Employing a relevance algorithm, the system of the invention continuously builds a knowledge base of user preferences in accordance with usage by the user and the manner in which the user reviews the information processed by the system to continuously refine the user's preferences by learning from the user's behaviour.

The user's preferences are normalised in accordance with, inter alia, relevant previous and current time period usage, meta tag interest scores and the manner and frequency with which the user follows links to external websites of interest to the user. The information presented to the user therefore reflects the user's real-time interests.

Accordingly, the system learns what types of information the user is interested in and can also recommend other information from other sources that the system has determined would be of interest to the user.

### BRIEF DESCRIPTION OF THE DRAWINGS

The invention will now be described, by way of example only, with reference to the accompanying drawings in which:

FIG. 1 is a flowchart of a general method and system in accordance with the invention for preventing email overload by processing emails between an external website and a user via an intermediate email address;

FIG. 2 is a flowchart of the method and system of FIG. 1 adapted to prevent email overload from daily deal websites in which daily deal coupon information is extracted from emails from daily deal websites, recorded and summarised for the user.

FIG. 3 is a flowchart showing detailed processing steps for extracting information from the PDF coupons processed as outlined in FIG. 2;

FIG. 4 is a flowchart of the method and system of the invention adapted for coupon re-selling in which a user account and/or a purchased coupon record is created by forwarding emails to a specific or dedicated email address of the system;

FIG. 5 is a flowchart of the method and system of FIG. 1 adapted to prevent email overload by subscription email newsletters from external newsletter websites in which electronic news content is extracted from the external websites and summarised in accordance with the user's preferences;

FIG. 6 is a flowchart of the method by which the email newsletter received from the external website in FIG. 5 is parsed by the email parser;

FIG. 7 is a flowchart of the algorithm employed in the method and system of FIG. 5 by which the relevance of information in the received email is determined;

FIG. 8 is a flowchart of a further embodiment of the invention of FIG. 1 in which the method and system of the invention is adapted to process emails and information between holiday accommodation websites, a seeker or user and a host, and

FIG. 9 is an exemplary system that provides a suitable operating environment for the method and system as outlined in FIGS. 1 to 8.

### DETAILED DESCRIPTION OF THE INVENTION

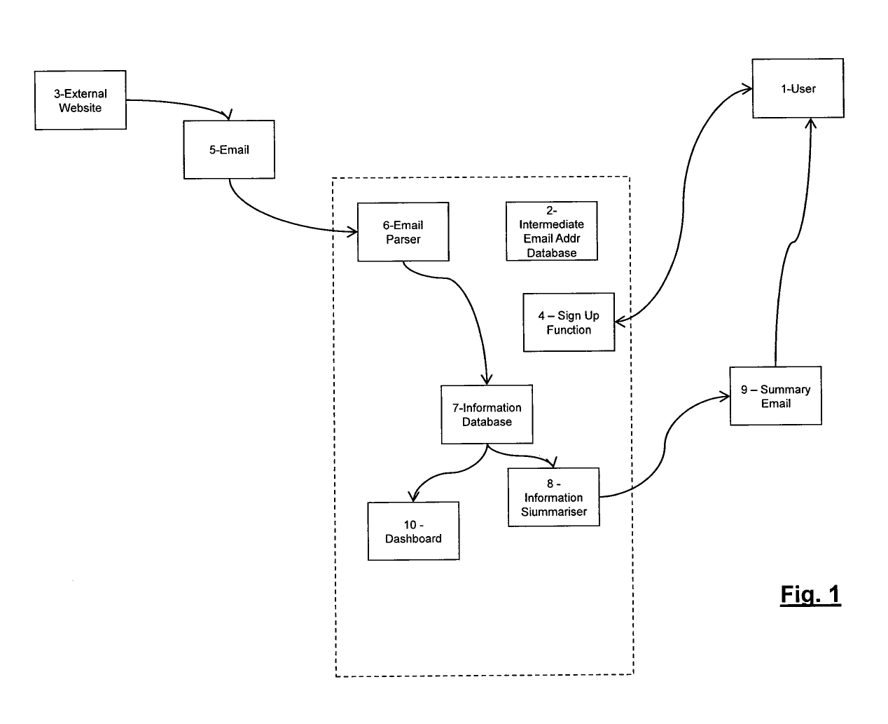

FIG. 1 is a flowchart of a first embodiment of a general method and system in accordance with the invention for preventing email overload by processing emails between an external website 3 and a user 1 via an intermediate email address stored on an intermediate email address database 2.

As shown in the flowchart, the user 1 signs up to the system of the invention in conventional manner via a user sign-up function 4 and is allocated an intermediate email address by the system. In the present embodiment, the intermediate email address is a user-specific intermediate email address. The user creates a logon ID and password to enable the user 1 to access the system of the invention as part of the sign-up process. Third party authentication services such as Open ID, Twitter (Trade mark) or Facebook (Trade Mark) may also be used to give the user 1 access to the system of the invention. The user-specific intermediate email address can be of a standard format i.e. made up of two parts—a mailbox identification and a hostname written as mailboxID@hostname e.g. joe@sift.ie which is stored in the intermediate email address database 2. The user 1 has the facility to modify the system generated mailbox identification and hostname if desired subject to a restriction that the user 1 is prevented from selecting an intermediate email address that is already in use.

The user 1 then browses the web in the usual manner using conventional search engines and the like. If the user 1 identifies an external website 3 with which the user 1 wishes to communicate and which requests an email address from the user 1, the user 1 provides the external website 3 with the user-specific intermediate email address created by the system of the invention rather than the personal email address of the user 1.

When the external website 3 sends an email 5 to the user 1, the email 5 is received by the system of the invention and not the user 1. The information contained within the email 5 is then parsed by an email parser 6 and information is extracted from the email 5 and stored in an information database 7. Examples of the information parsed, extracted and stored in the information database 7 from the email 5 can include the source email 5 address, the “reply to” email address, the subject of the email 5, the date and time sent of the email 5 and the entire content of the email 5.

Accordingly, the system of the invention determines the subject matter in the received email 5 and stores this in the information database 7. As outlined more fully below, an information summariser 8 then summarises the extracted information into a summary email 9 which is then sent to the private email address of the user 1. The summary email 9 is also displayed on a dashboard 10 within the system to which the user 1 has access. Accordingly, if desired, the user 1 can also access the system of the invention and view summarised emails 9 on the dashboard 10.

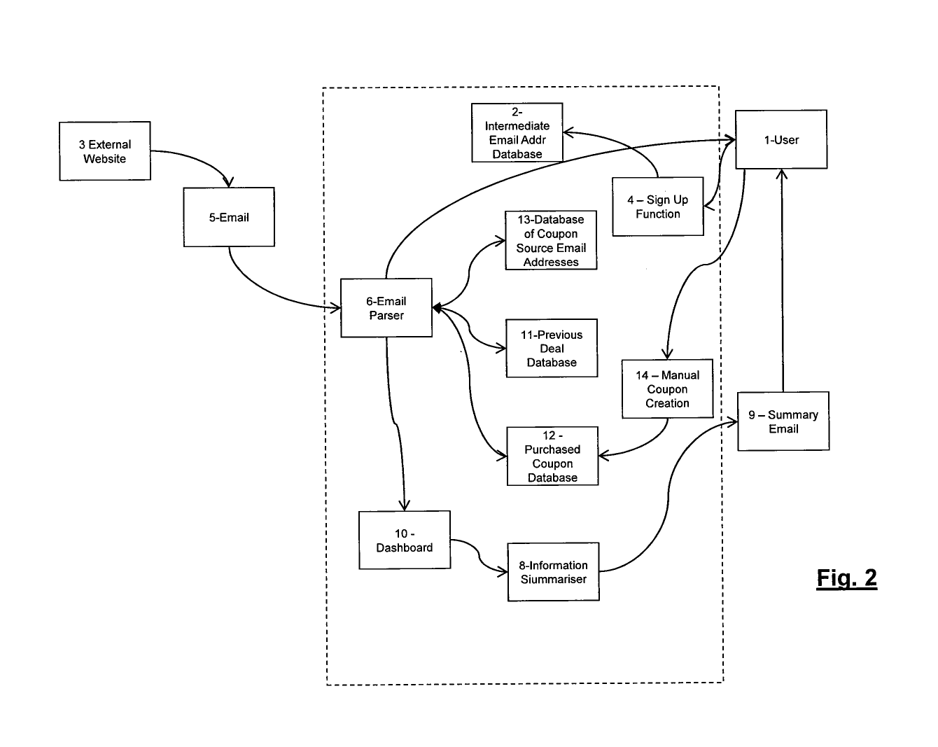

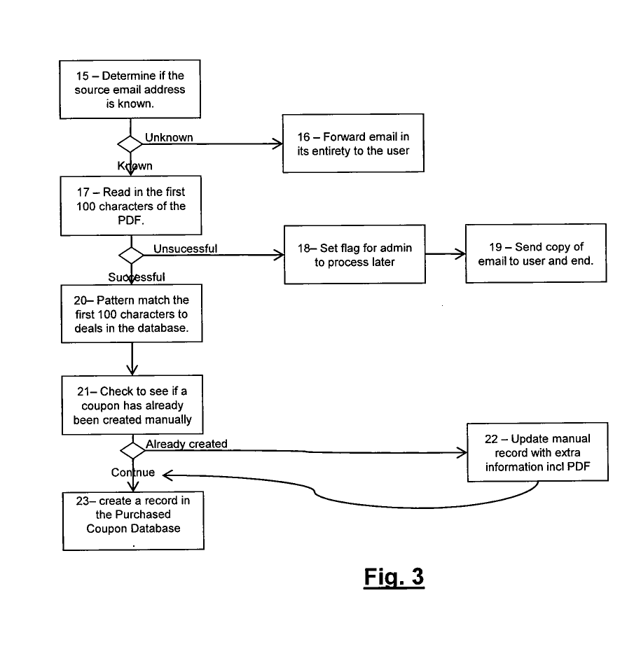

FIG. 2 is a flowchart of an embodiment of the invention adapted for processing and handling coupons. More particularly, FIG. 2 is a flowchart of the method and system of FIG. 1 adapted to prevent email overload from daily deal websites in which daily deal discount coupon information is extracted from emails from daily deal websites, recorded and summarised for the user 1. FIG. 3 is a flowchart showing detailed processing steps for extracting the required information from the daily discount coupons in PDF format described in FIG. 2. Like numerals indicate like parts.

As shown in FIG. 2, the user 1 signs up to the system of the invention using the sign-up function 4 and receives a user-specific intermediate email address 2 as previously described. The user 1 can then provide the user-specific intermediate email address to external websites 3 when purchasing coupons from or signing up to the external websites 3.

The system of the invention constantly searches the internet for daily deals and keeps a record of all deals located in a previous deal database 11. A variety of known methods can be employed to perform the searches such as accessing application programming interfaces from providers, reading RSS (Really Simple Syndication) feeds and scraping websites to extract the required information from the websites. Representative information stored in the previous deal database 11 includes, pre-discount value of the coupon, discount percentage, discounted value, expiration date, title, description, web address of the page for the daily deal and web address of an image associated with the deal.

Coupons are transmitted in conventional manner to the user 1 via email 5 to the intermediate email address. The email 5 is received by the system of the invention as previously described. The email parser 6 recognises the email 5 as conveying a coupon to the user 1 and, optionally, depending on the user's preferences, can forward the email 5 to the user's 1 private email address. In the event that the user opts not to have the email forwarded to them directly, the fact that a coupon has been received is displayed on the dashboard 10 and the information summariser 8 includes information with regard to the received coupon in the summary email 9 sent to the user 1.

The system of the invention also stores a copy of both the email 5 and any attached coupon in a purchased coupon database 12.

The system of the invention identifies the email 5 as being a coupon-related email by checking the source email address against a database of coupon source email addresses 13 maintained by a system administrator.

The previous deal database 11, the purchased coupon database 12 and the database of coupon source email addresses 13 define the information database 7 of FIG. 1.

The system of the invention reads the contents of the email 5 and any attached coupon that could potentially be in a PDF format or similar using either commercially available software routines or open source software routines.

The system of the invention then matches the contents of the email 5 and/or any attached PDF or similar files to previous coupons or deals maintained in the previous deal database 11. As indicated above, the representative information stored in the previous deal database 11 includes pre-discount value of the coupon, discount percentage, discounted value, expiration date, title, description, web address of the page with the deal and web address of an image associated with the deal.

In the case of an attached PDF file coupon, matching is performed by reading in a number of characters from the deal description in the PDF file and using a Pattern Matching Algorithm to match the characters to the descriptions of deals already held in the previous deal database 11. The system also provides a manual coupon creation facility 14 for the user 1 to manually create a deal which is also stored in the purchased coupon database 11. FIG. 3 is a flowchart of describing the Pattern Matching Algorithm in detail.

As shown in the flowchart, the system of the invention first performs a determination step 15 to determine if the source email address is known. More particularly, the source email address of the email 5 is compared with the coupon source email addresses on the coupon source email address database 13. If no match is found, the system forwards the email 5 to the user 1 in its entirety 16 together with a message to indicate that it could not find a match for the attached document.

Where a match to a known coupon source email address is identified in the coupon source email address database 13, the system reads into memory 17 the first 100 characters contained in the text of the PDF coupon. As will be appreciated by those skilled in the art the number of characters read into memory 17 can be varied as required.

In the event that a carriage return is identified in the first 100 characters, then only the characters up to the carriage return are read into memory 17. The character string read into memory is termed the Read In Deal Description.

In the event that the Read In Deal Description is not successfully created and read into memory 17 or that no PDF is attached to the email 5, the system sets an error flag 18 for later processing by the administrator and stores the PDF file to enable the user 1 to retrieve the PDF file and sends an email 19 to the user 1 informing the user 1 of the stored PDF file.

Where the Read In Deal Description is created, the system then performs a pattern match analysis 20 on the Read In Deal Description to identify any commonalities between the Read In Deal Description and previous deal descriptions of deals originating from the same source email address stored on the previous deal database 11. Commercially available pattern matching software routines or open source pattern matching software routines are used to carry out the pattern matching analysis 20. The degree of pattern matching 20 required for the system to deduce that there is a match is set by the administrator.

Where a match is deduced, the system then performs a process check 21 to determine if a manual coupon has already been created by the user 1 employing the manual coupon creation facility 14 described above. If the system recognises the existence of the pre-existing manually created record, a duplicate new record is not created and the system of the invention performs an updating exercise 22 so that the manually created record is updated with any extra information extracted from the email 5.

The duplicate record avoidance check process 21 is achieved as follows:

a. Identify the deal as described above;
b. For that particular user 1 search the purchased coupon database 12 to see if a record indicating that that deal has already been purchased exists. If it has, then the PDF file associated with the deal is stored in the record for the manually created deal;
c. A new additional deal purchase record is not created.

If the record has not been created manually, the system creates a new record 23 that the deal has been purchased in the purchased coupon database 12. The details of the coupon will have already been stored in the previous deals database 11. The details including pre-discount value of the coupon, discount percentage, discounted value, expiration date, title, description, the web address of the page with the deal, the web address of an image associated with the deal are then copied from the previous deals database 11 to the purchased coupon database 12.

The system of the invention autopopulates or displays purchased deals on the dashboard 10. As previously described, the information summariser 8 also summarises this information and sends a summary email 9 to the user 1. The summary email 9 also includes notification of when a coupon is close to expiring.

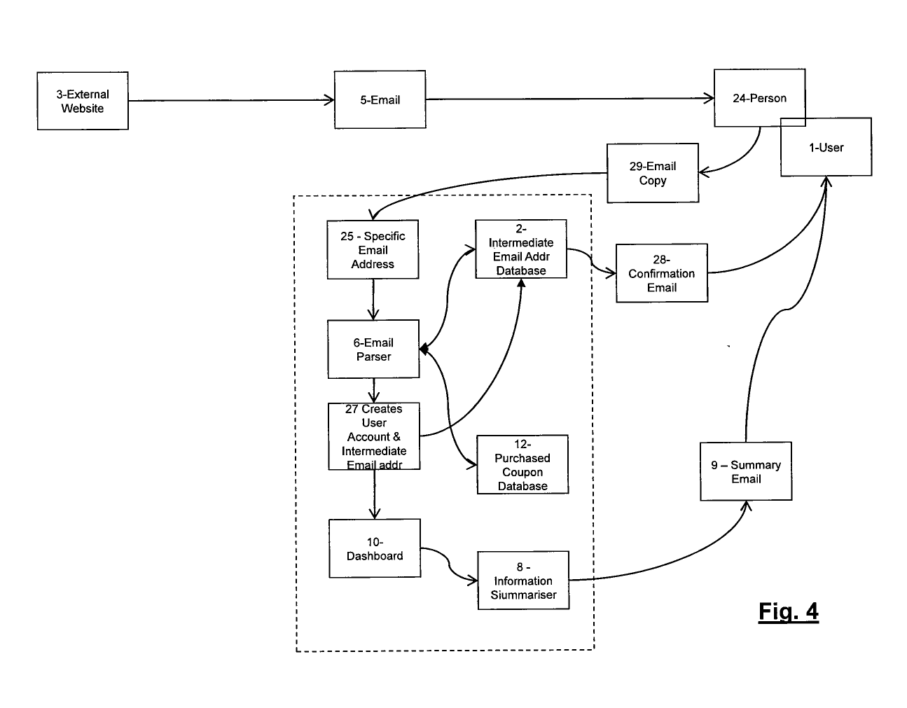

FIG. 4 is a flowchart of a further embodiment of the invention adapted for coupon re-selling in which a user account and/or a purchased coupon record is created by forwarding emails to a specific or dedicated email address of the system. Like numerals indicate like parts.

As shown in the drawing, when a person 24 who is yet to become a user of the system of the invention purchases a coupon from an external website 3 in the usual manner, the external website 3 sends the person 24 an external email 5 with an attached coupon—typically as a PDF file as previously described.

The person 24 then forwards a copy 29 of the external email 5, including a copy of the attached coupon, to a dedicated email sorting system-specific intermediate email address 25 within the system e.g. sellmycoupon@sort.ie or trackmycoupon@sort.ie.

The email parser 6 checks to see if the person is already signed up to the system by checking to see if the email address the email came from is associated with an existing user account 27. If the user is not already signed up, the system automatically creates a user account 27 in the system for the user. The system can also allocate a user-specific intermediate email address to the user 1. The system sends a confirmation email 28 to the user 1 to indicate that a user account has been created for the user 1 as well as details of the user-specific intermediate email address. The confirmation email 28 includes a link for the user 1 to click to confirm the creation of an account.

The system of the invention then replicates the procedure described in FIGS. 2 and 3 above to automatically create a record in the purchased coupon database 12 for display on the dashboard 10 to be summarised by the information summariser 8. A summary email 9 is then sent to the user 1.

In the event that the user 1 is already signed up and has an account and a user=specific intermediate email address, the user account creation 27 and intermediate email address generation processes are omitted. Accordingly, an existing user 1 has an alternative method of creating a record in the purchased coupon database 12 by simply forwarding the coupon to the dedicated email sorting system-specific intermediate email address.

The coupon can then be sold by the user 1 if required.

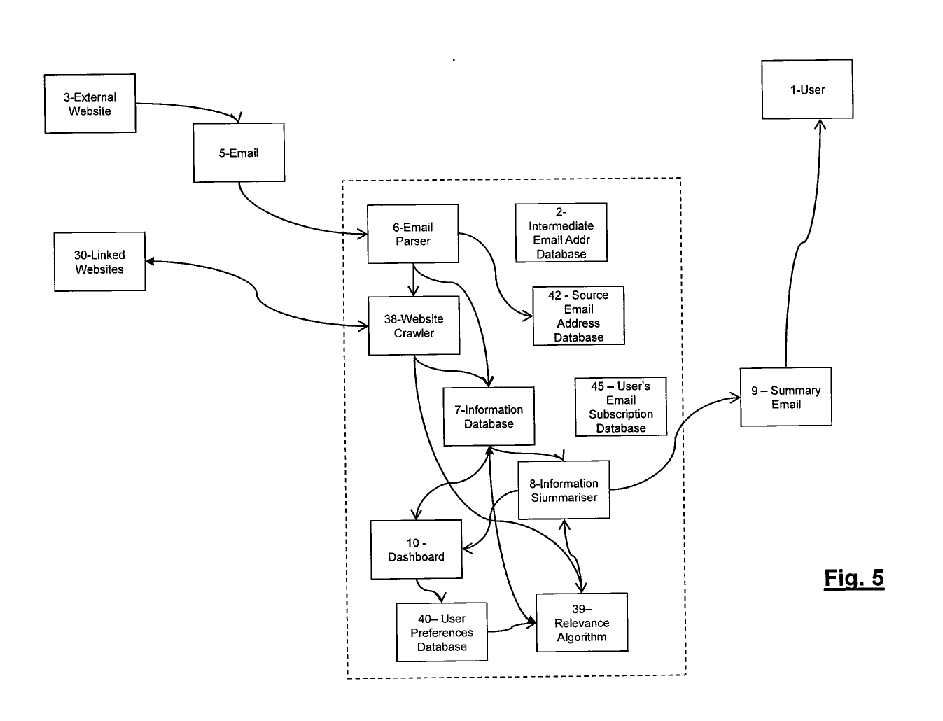

As outlined more fully below, FIG. 5 is a flowchart of the method and system of FIG. 1 adapted to prevent email overload by subscription email newsletters from external newsletter websites 3 in which electronic news content is extracted from the external websites 3 and summarised in accordance with the user's 1 preferences.

Like numerals indicate like parts.

Although the sign-up function 4 is not shown in FIG. 5, the user 1 signs up to the system as described above and is allocated a user-specific intermediate email address which is stored in the intermediate email address database 2. The signed-up user 1 uses the user-specific intermediate email address created by the system of the invention as described above when subscribing to an information newsletter in the form of an email 5 from the external website 3. Often the email newsletter 5 will contain a plurality of news summaries in the form of digests of information with links to the full information or news article on web pages on the external website 3 or other external linked websites 30 to which links are to be found in the email newsletter 5.

The user 1 then browses the web in conventional manner. As previously described, should the user 1 wish to subscribe to an email newsletter 5 distributed by an external website 3, the user provides the external website 3 with the user-specific intermediate email address instead of the user's personal email address.

When the external website 3 wishes to send an email newsletter 5 to the user 1, the email newsletter 5 is received by the sorting system of the invention at the user-specific intermediate email address. The email newsletter 5 is then parsed by the email parser 6 and information is extracted from the email newsletter 5 and stored in the information database 7. In the present embodiment, the information parsed, extracted and stored in the information database 7 from the email newsletter 5 includes the source email 5 address, the “reply to” email address, the subject of the email newsletter 5, the date and time sent of the email newsletter 5 and the entire content of the email newsletter 5.

The email parser 6 determines if the email newsletter 5 is organised into generally separate digests of information, each digest comprising a summary of a news item and each digest or news item associated with a link to a target web page on the external website 3 or another external linked website 30.

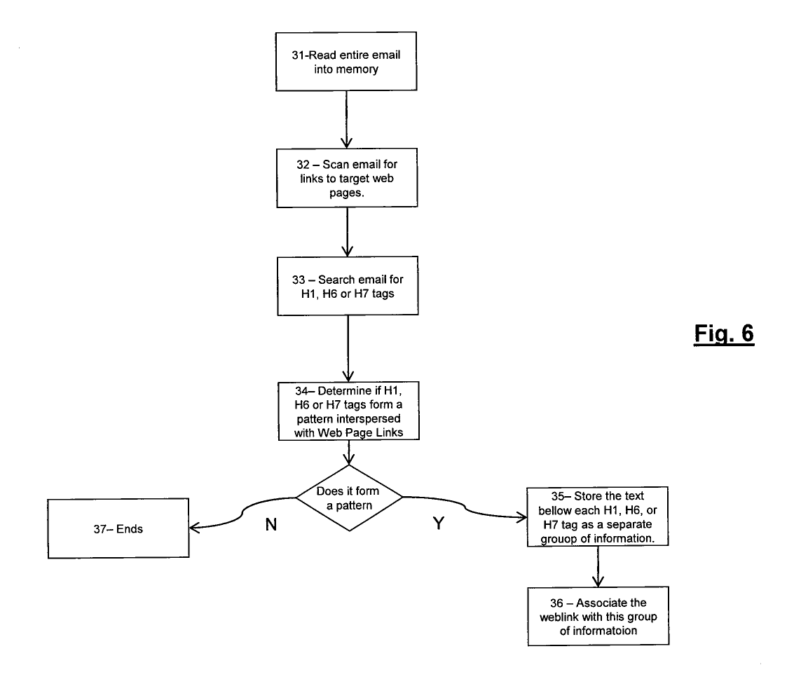

The process by which the email newsletter 5 is parsed by the email parser 6 is described in detail in the flowchart of FIG. 6. As shown in the flowchart, the entire email newsletter 5 is first read into memory 31 and the email newsletter 5 is then scanned 32 for links to target web pages on external websites 3,30. The email newsletter 5 is then scanned 33 for H1, H2 or H3 Heading Tags. The H1, H2, H3 Heading Tags are then parsed 34 to determine if the Heading Tags form a pattern interspersed with external web page links 3,30. If a pattern interspersed with external web page 3,30 links is identified i.e. “Yes”, the text below each H1, H2, or H3 Heading Tag is stored as a separate group of information 35 on the information database 7. The relevant web link to an external website 3,30 is then associated 36 with the group of information 35 on the information database 7. If no pattern is identified in the H1, H2, H3 Heading Tags, the email parser 6 then ends 37.

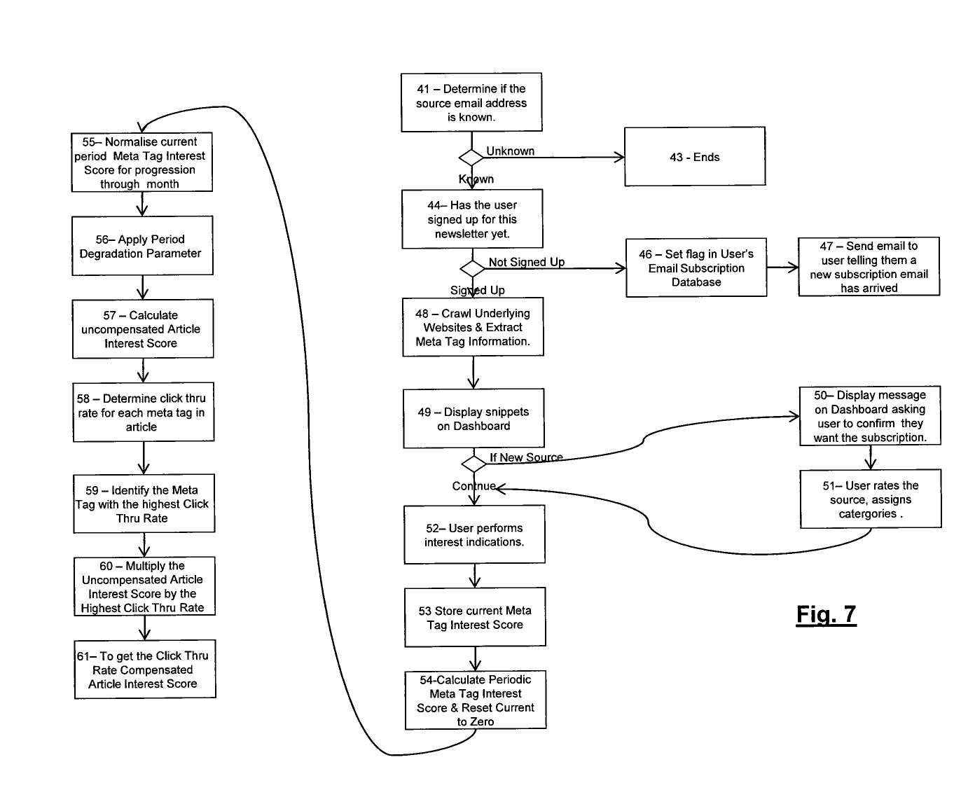

If the process outlined in FIG. 6 has identified links in the email newsletter to external websites 3,30, the external websites 3,30 are crawled by a website crawler 38 in the system of the invention and information is extracted from the crawled external websites 3,30 and stored in the information database 7. The information extracted from the email newsletter 5 and external websites 3,30 which has been stored in the information database 7 is then subjected to a relevance algorithm 39 which is described more fully below in the flowchart of FIG. 7.

The relevance algorithm 39 determines the relevance of each digest to the user 1 so that the digests can be autopopulated hierarchically on a dashboard 10. The contents of the dashboard 10 are summarised by the information summariser 8 into a summary email 9 which is sent by the system to the private email address of the user 1. The information summariser 8 generates the summary email 9 using the relevance information created by the relevance algorithm 39 to prioritise what information is sent to the user 1 in the summary email 9.

The user 1 can read the information in the summary email 9 or view all summarised emails autopopulated on the dashboard 10.

The user 1 can adjust filter settings in the dashboard 10 to change the quantity of information displayed on the dashboard 10. Typical filter settings include source of email filters, age filters and Meta Tag filters. The quantity of information displayed and the level of detail can be adjusted e.g. changing from a display of 10 separate digests displayed with paragraph length summaries to 20. As an example a user 1 may use the filter settings to show only information from a particular external website 30 over a selected period as required e.g. information from a specified website filtered using a Meta Tag filter of “Venture Capital” and a time period of the previous two months.

The dashboard 10 also contains links to the external websites 3,30 which can be followed if desired by the user 1. As described more fully below, using the relevance algorithm 39 the user 1 can also perform Interest Indications on the digests which are stored on a user preferences database 40 so that the information presented in the summary email 9 and on the dashboard 10 is in accordance with the user's preferences.

As shown in detail in FIG. 7, the relevance algorithm 39 operates as follows.

Upon receipt of an external email 5, the system and method of the invention determines 41 whether or not the email 5 is from a source already known to the system of the invention by checking to see if the source email address is recorded in a source email address database 42. If not, the relevance algorithm 39 is terminated and the system administrator examines the source and updates the source email address database 42 if necessary. The source email address database 42 is under the control of the system administrator and can be pre-populated with lists of known source email addresses that are sources of newsletters. A masking technique can be employed when pre-populating so that all email sources that correspond to the mask will automatically be recognised as email newsletter sources. An example of a masking technique is “*@*feedburner.com” which would indicate that any email sources where the email address is made up of any letters where the stars are but has “feedburner.com” as the last letters would be classified as a known source.

In the event that the source is not known then the processing is terminated 43 thereby eliminating unsolicited or undesirable emails.

The system of the invention determines if the user 1 has already signed up for an email subscription 44 by reviewing the user's email subscription database 45.

If it is, it proceeds. If not, the external email 5 is most likely an email asking the user 1 to confirm that the user 1 has signed up for the relevant newsletter. In this event, a new source flag 46 is set in the user's email subscription database 45 record for that source email subscription. The system of the invention then sends an email 47 to the user 1 indicating that a new subscription email has been received and recorded.

Alternatively, where the subscription is known to the user's email subscription database 45, the system of the invention receives intermittent newsletter emails 5 addressed to the intermediate email address of the user 1 which typically consist of digests of information from known external websites 3,30 pointing to specific underlying web pages in linked websites 3,30 which emails 5 are processed as follows.

The website crawler 38 crawls the underlying web page 48 on the linked website 30 to extract Meta Tag information about the underlying web page and the news article on it. The website crawler 38 stores the source, the category and the author of each digest in the information database 7.

The digests of information are displayed 49 to the user 1 on the dashboard 10 when the user 1 logs into the system. The digests are sorted into three or more display groups each with different length digests of data associated with them. The digests are sorted based on the relevance algorithm 39 described herein according to the Click Through Rate Compensated Article Interest Score (described in more detail below) for each digest. For example, the five most interesting digests can be in the top display group and may have five lines of the digest displayed. The next five most interesting digests can be displayed in the next display group and have two lines of description while the remainder may be displayed in a third display group in a summary fashion.

In the event that the user 1 has received a newsletter email 5 from a website 3 for which the user 1 has not signed up to as stored in the user's email subscription database 45 the system presents information on this external website 3 or source at the top of the dashboard 10 and requests the user 1 to
1. Confirm 50 that the user 1 desires the subscription. If the user 1 indicates the user 1 wishes to receive the subscription, the new source flag is cleared and the user's email subscription database 45 is updated to indicate that this email source is a valid email subscription. This is described in more detail below.
2. The user is also requested to select a source rating 51 from a pre-determined list to rate the source and to indicate how the user 1 wishes the system to treat information from that external website 3. In the present embodiment, the pre-determined source ratings are
   (1) Pass through—send all emails from this source directly to my inbox.
   (2) High—initially show in display group one.
   (3) Medium—initially show in display group two.
   (4) Low—initially show in display group three.

In the event that a user 1 is new and there is little or no information about the user's 1 preferences stored in the user preferences database 40, the source ratings illustrated above are used to determine which display group in which each digest should be displayed.

As the user 1 uses the system, information about the user's preferences is built up and stored in the user preferences database 40.

The system of the invention also maintains a list of categories which are managed by the data administrator via administration facilities on the website.

Typical categories are sport, politics, technology, business, etc. Each category can have sub-categories such as sport/soccer, sport/golf and the like.

The user 1 is also asked when selecting a source rating 51 to assign the source or external website 3 to one of the categories.

Each time a digest is displayed on the dashboard 10 to the user 1, the system stores the Meta Tags associated with that digest to enable an Interest Indication of each Meta Tag to be stored in the user preference database 40.

The user can then perform any one of the following Interest Indications 52:
“Click Through” to view the underlying target web page;
“Not Click Through” i.e. do nothing and not look at the underlying linked target web page;
“Like The Digest” i.e. indicate on the dashboard 10 by clicking a button that the user 1 likes the digest;
“Dislike The Digest” i.e. indicate on the dashboard 10 by clicking a button that the user 1 dislikes the digest.
“Share The Digest” via social media.

Each time the user 1 performs an Interest Indication as described above, or does nothing by not clicking through, the system records an Interest Indication for each user/Meta Tag combination in the user preferences database 40. An incidence of a Not Click Through is only recorded if a digest in the same display group has been Clicked Through e.g. if six digests are presented in the top display group and one of these six is Clicked Through, then the other five are recorded as an incidence of a Not Click Through. If six are displayed but none are Clicked Through, then no interest incidence is recorded.

The system of the invention maintains an Interest Indication Multiplier for each Interest Indication as described above. The Interest Indication Multipliers are maintained by the data administrator. Illustrative Interest Indication Multipliers for each are

### i) Interest Indication Multiplier for Click Through=1

### ii) Interest Indication Multiplier for Not Click Through=−1

iii) Interest Indication Multiplier for Like The digest=2

### iv) Interest Indication Multiplier for Share Via Social Media=4

### v) Interest Indication Multiplier for Dislike The Digest=−2

A Meta Tag Interest Score for each user/Meta Tag combination is maintained as follows. Each Interest Indication is multiplied by the appropriate Interest Indication Multiplier for each Meta Tag and added together. Accordingly, if a digest with a Meta Tag “Venture Capital” has received a Click Through (Interest Indication Multiplier=1), then the user/Meta Tag combination=“Venture Capital” would have a score of 1. If subsequently, the user 1 performs the action Like The Digest (Interest Indication Multiplier=2) on a different digest that had the Meta Tag “Venture Capital”, then a score of 2 would be added to the user/meta tag combination=“Venture Capital” and added to the existing score of 1 to give a total score of 3. If the user 1 performs multiple Interest Indications on the same digest, e.g. a Like and a Click Through, then the scores are added together.

At any point in time the system of the invention maintains a Current Meta Tag Interest Score 53 for each user/Meta Tag combination in the user preferences database 40.

At the end of a pre-determined period, e.g. weekly, monthly or other desired period, as set by the system administrator, the system of the invention calculates a Periodic Meta Tag Interest Score 54 and saves it. This is to speed up processing as the Relevance Algorithm 39 can use summarised data rather than raw underlying data. The Current Meta Tag Interest Score 53 is then reset to zero and starts to increment again in the new period.

The system of the invention determines a user's 1 current interests as follows. As described above, the system maintains a Current Meta Tag Interest Score 53 for the Current Period (week, month or other as required) for all possible combinations of user/Meta Tag the user 1 has clicked through or not clicked through previously.

Moreover, if for example the Current Period was a month, and it was early in the month, the Current Meta Tag Interest Score 53 could be artificially low. Accordingly, the system of the invention normalises the Current Meta Tag Interest Score 53 based on the degree of progression through the period as follows:

$$\frac{\begin{matrix}( Current Meta Tag Interest Score ) + \\ ( Periodic Meta Tag Score )\end{matrix}}{\begin{matrix}( Day Number In Current Period ) + \\ ( Total Number Of Days In Current Period )\end{matrix}}$$

For example, if the Current Period were a month, it was the 15^{th} day of the month, and the Current Meta Tag Interest Score 53 to date in the current month was 5 and the Periodic Meta Tag Interest Score was 10 in the previous month, the Current Meta Tag Interest Score would be normalised to

(5+10)/(15+31)

where the current month has 31 days.

The system of the invention also performs an Age or Period Degradation Analysis 56 on the Periodic Meta Tag Interest Scores when processing new digests to allow for situations where for example a user 1 may have been very interested in a newsletter subject from January through June but not interested in the subject from July through December. A Final Meta Tag Interest Score results.

The Final Meta Tag Interest Score is determined by taking the Periodic Meta Tag Interest Scores 54 for all preceding periods and multiplying them by a Period Degradation Parameter set by the system of the invention and maintained by the data administrator. The formula is as follows:

$$I = {\sum }_{0}^{n} {i}_{n} * {d}_{n}$$

where I=Final Meta Tag Interest Score, iₙ=Period Meta Tag Interest Score for the period n and dₙ is the age degradation parameter for the period.

Expressed in words, the Final Meta Tag Interest Score is equivalent to the cumulative sum of the (Current Meta Tag Interest Score*Age Degradation Parameter)+(Periodic Meta Tag Interest Score for each previous month*Age Degradation Parameter for that previous month) up to the total number of periods to be processed.

The calculation of a Final Meta Tag Interest Score is illustrated in the following non-limiting Example.

In the present Example, the time period is considered to be a month and the Age Degradation Parameters have been set by the data administrator as follows:

TABLE 1
Age Degradation Parameters

| Month | Age Degradation Parameter |
|---|---|
| 0 | 1 |
| −1 | 0.7 |
| −2 | 0.3 |
| −3 | 0.2 |
| −4 | 0.2 |
| −5 | 0.1 |
| −6 | 0.1 |
| −7 | 0.1 |
| −8 | 0.1 |
| −9 | 0.1 |
| −10 | 0.05 |
| −11 | 0.05 |
| −12 | 0.05 |

As outlined above, the Final Meta Tag Interest Score is equivalent to the cumulative sum of the

(Current Meta Tag Interest Score*Age Degradation Parameter)+(Periodic Meta Tag Interest Score for each month*Age Degradation Parameter for that month)

Accordingly, using the Age Degradation Parameters of Table 1,

Final Meta Tag Interest Score=(Current Meta Tag Interest Score*1)+(Periodic Meta Tag Interest Score Month−1*0.7)+(Periodic Meta Tag Interest Score Month−2*0.3)+(Periodic Meta Tag Interest Score Month−3*0.2) etc.

The system of the invention also processes the news articles in received email newsletters 5 to determine an Uncompensated Article Interest Score 57 for each news article. Calculation of the Uncompensated Article Interest Score 57 is described below.

As outlined above, the system of the invention receives the email newsletters 5 with digests of information and crawls the underlying external or linked websites 3,30 target web pages with the website crawler 38 to extract the Meta Tags associated with the underlying web page.

In the present example, following crawling, the following Meta Tags were extracted

### i) Twitter (Trade Mark)

### ii) Facebook (Trade Mark)

iii) Venture Capital

### iv) Valuations

### v) Sergey Brin

For each Meta Tag extracted, the system retrieves the previously calculated user's 1 Current Meta Tag Interest Score 53 for that Meta Tag from the user preferences database 40 for use in the calculation. As described above, Current Meta Tag Interest Scores 53 have been built up over time based on the user's 1 previous usage. Typical data is given in the table below.

TABLE 2
Current Meta Tag Interest Scores Based On User's History

| | | Current Meta Tag |
|---|---|---|
| # | User/Meta Tag Combination | Interest Score |
| 1 | Twitter (Trade Mark) | 50 |
| 2 | Facebook (Trade Mark) | 40 |
| 3 | Venture Capital | 30 |
| 4 | Valuations | 20 |
| 5 | Sergey Brin | 10 |

The system of the invention performs a qualitative analysis hereinafter referred to as a Meta Tag Influence Degradation Routine on the Current Meta Tag Interest Scores 53 identified above to ensure that a news article having a large number of Meta Tags associated with it does not automatically score higher than a news article with fewer Meta Tags. The Meta Tag Influence Degradation Routine results in the Uncompensated Article Interest Score 57 and is performed using User Tag Degradation Parameters maintained by the data administrator. Sample User Tag Degradation Parameters are given in Table 3 below where the term “Tag Influence” is a generic term for each Meta Tag and Tag Influence 1 refers to the highest scoring Meta Tag and Tag Influence 2 refers to the next highest scoring Meta Tag etc.

TABLE 3
User Tag Degradation Parameters

| Tag Influence | User Tag Degradation Parameter |
|---|---|
| Tag Influence 1 | 1 |
| Tag Influence 2 | 0.5 |
| Tag Influence 3 | 0.2 |
| Tag Influence 4 | 0.1 |
| Tag Influence 5+ | 0 |

Using the User Tag Degradation Parameters, the Uncompensated Article Interest Score is calculated as follows:

(Tag Influence 1*User Tag Degradation Parameter)+(Tag Influence 2*User Tag Degradation Parameter)+(Tag Influence 3*User Tag Degradation Parameter)+(Tag Influence 4*User Tag Degradation Parameter)+(Tag Influence 5*User Tag Degradation Parameter)+(Tag Influence 5+*User Tag Degradation Parameter).

Accordingly, in the present Example,

Uncompensated Article Interest Score=50+(40*0.5)+(30*0.2)+(20*0.1)+(10*0)=78

The system of the invention also normalises the Current Meta Tag Interest Score for Meta Tags which, although they may be of interest to the user 1, appear infrequently and hence could receive an artificially low Current Meta Tag Interest Score i.e. some Meta Tags may be both of interest to the user and common from a frequency of repetition perspective while other Meta Tags may be equally of interest but less common. As an example, the Meta Tag “Twitter” might be very frequent in articles but is only clicked through 20% of the time. Even though the Click Through Rate is only 20%, the frequency of the occurrence of the Meta Tag ensures it will have a relatively high score. By contrast, the Meta Tag “Sergey Brin” is not as common but the User 1 clicks through 50% of the time indicating that the User 1 is very interested in this topic.

The normalised Current Meta Tag Interest Score is referred to as the Click Through Rate Compensated Article Interest Score 61. The system of the invention calculates the Click Through Rate Compensated Article Interest Score 61 as follows.

The Click Through Rate for each Meta Tag in each digest is determined 58 by applying the formula:

$$Click Through Rate = \frac{Click Throughs}{Click Throughs + Not Click Throughs}$$

In the present example, the historical Click Through Rates for each Meta Tag for this particular user 1 are indicated in Table 4 below.

TABLE 4
Historical Click Through Rates

| | | Current Meta Tag | Historical Click |
|---|---|---|---|
| # | User/Meta Tag Combination | Interest Score | Through Rates |
| 1 | Twitter (Trade Mark) | 50 | 20% |
| 2 | Facebook (Trade Mark) | 40 | 15% |
| 3 | Venture Capital | 30 | 30% |
| 4 | Valuations | 20 | 13% |
| 5 | Sergey Brin | 10 | 50% |

The Meta Tag with the highest Click Through Rate is then identified 59. As indicated above, this may or may not be the Meta Tag with the highest Current Meta Tag Interest Score 53.

In the present example the Meta Tag with the highest Click Through Rate was “Sergey Brin” which has a historical interest score of 50%.

The Uncompensated Article Interest Score 57 is multiplied by the highest Click Through Rate of any Meta Tag in the article 60, to calculate the Click Through Rate Compensated Article Interest Score 61.

In the present example, the Uncompensated Article Interest Score is 78 and the highest Click Through Rate is for Sergey Brin at 50%. Accordingly,

Click Through Rate Compensated Article Interest Score=78*50%=39.

The above analysis is repeated for each article and the articles are ranked according to the analysis.

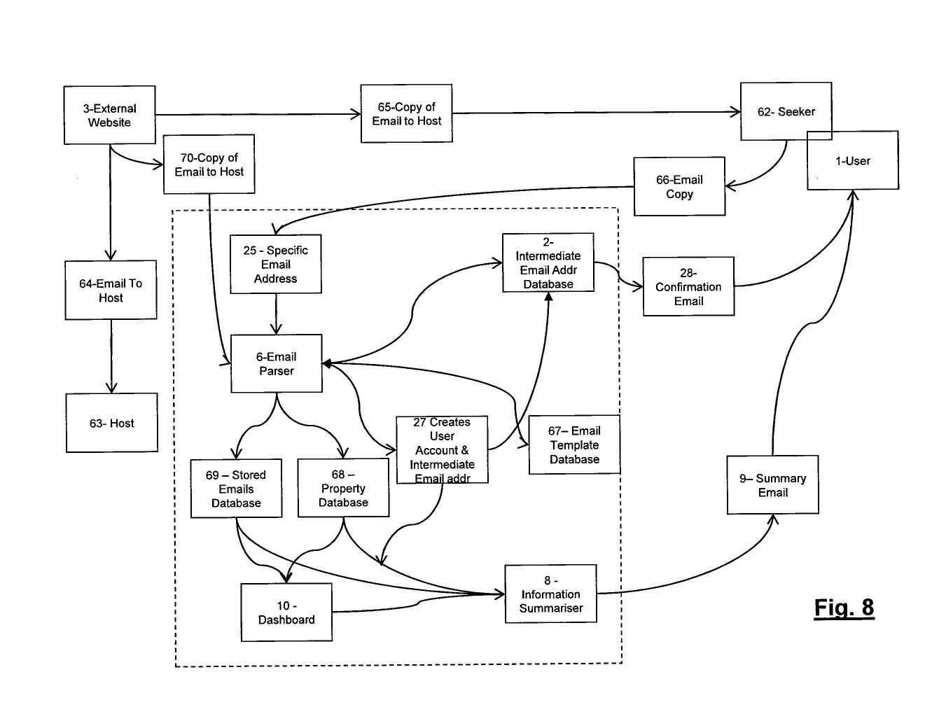

FIG. 8 is a flowchart of a further embodiment of the invention of FIG. 1 in which the method and system of the invention is adapted to process emails and information between holiday accommodation websites, a seeker or user and a host. Like numerals indicate like parts.

As shown in the drawing, a holiday accommodation seeker 62 searches on the web for holiday rental accommodation using a search engine in conventional manner and the search engine directs the seeker 62 to a holiday accommodation listings external site 3 where the seeker 62 can enter information such as the geographical location and property type required. Typically, the seeker 62 is then directed to an advertisement for a property and completes an online form in which the seeker 62 provides contact details including the seeker's private email address. The website 3 then sends a reporting email 64 to the person or company who placed the advertisement (hereinafter referred to as a host 63) summarising the seeker's contact information, required rental dates and other information which may include a free form message. A copy of the reporting email or other communication is sent to the seeker 62 for reference.

The seeker 62 forwards 66 the reporting email 64 from the seeker's 62 private email address to a dedicated email sorting system-specific intermediate email address 25 such as plans@sort.ie controlled by the system of the invention. As previously described, an email parser 6 checks to see if the originating email address is already associated with a user account in the intermediate email address database 2. If not, a user-specific intermediate email address and user account 27 is created for that seeker 62. The user-specific intermediate email address is stored in the intermediate email address database 2 and a confirmation email 28 sent to the seeker 62 who is now a user 1 of the system of the invention.

The email parser 6 then analyses the received reported email 66 and compares it to template emails stored in a template emails database 67. If the format of the email matches one of the stored templates, the email parser 6 decodes and extracts the information in the email such as the name of the property, dates required, photographs, freeform messages etc and stores the information in a property database 68. The reported emails are stored in a stored emails database 69.

The template emails database 67, the property database 68 and the stored emails database 69 are equivalent to the information database 7 of FIG. 1.

A list is then constructed of the extracted and decoded information for display on a dashboard 10. The user 1 can also add additional information about the property to the dashboard 10 as required e.g. email address for the host, number of bedrooms, distance from the sea, or a freeform comment to this database on the property. All information entered by the user 1 is also stored in the property database 68.

The computer software also searches the stored emails database 69 to locate other stored emails relating to the property. If additional information relating to the property is identified, the additional information is retrieved and added to the dashboard 10. If the reported email received from the seeker 62 or user 1 does not have the email of the host 63 identified in it, the system also searches its stored emails database 69 to identify the property, e.g. by matching the name of the property, or a combination of the holiday listings website 3 and reference ID of the property on the website. If a match is successful, the system displays any additional information about the property available from the property database 68.

An information summariser 8 then sends a summary email 9 to the user 1 to inform the user 1 that the reported email has been received and processed and extracted and retrieved information displayed on the dashboard 10.

Should the user 1 receive further email correspondence from the host 63 to the user's 1 private email address, the user 1 can forward the email to the system where it is processed and identified as previously described and added to the list of communications presented to the user 1 on the dashboard 10.

Following sign-up, the user 1 can use the user-specific intermediate email address generated for the user 1 as the contact email when completing online forms on holiday rentals listings on external website 3. In the event they do this, the emails from the website 3 go directly to the email parser 6. Emails from the external websites 3 are therefore transmitted directly from the external website 3 to the email parser 6. The email parser 6 then parses this information in a similar manner to that described above for display on the dashboard 10. The information summariser 8 then forwards a notification email to the user 1 summarising the emails that have been received together with a link to the dashboard 10.

A host 63 can also sign up to system of the invention in a similar way to that described above for a seeker 62 by forwarding an email to the system. The host 63 is provided with a host-specific intermediate email address equivalent to a user-specific intermediate email address. The host-specific intermediate email address can then be employed by the host 63 as the default email address on holiday rentals listings websites. Accordingly, inquiry emails received by the holiday rentals websites 3 from seekers 62 are processed, summarised and displayed on the dashboard 10 for the host 63 as outlined above. The system may also pass the inquiry email or a summary of it on to the host 63.

The system is adapted to store information about each property belonging to the host 63. Key information relevant to seekers 62 and hosts 63 alike is a calendar of property availability. The host 63 identifies on the calendar of property availability what days are available to rent and what are not. When an inquiry is received by the system of the invention, the system associates the inquiry with a date period and indicates on a calendar interface on the system the dates required in the inquiry. If the dates in question are not available, the system can be optionally configured to reply automatically to state that this is the case.

The host 63 can also store pricing information against periods of time on the calendar of availability e.g. according to peak season, low season, public holidays and the like. The host 63 can also set up template messages that can derive information from both the calendar of property availability and the pricing by date information so that the template messages can be sent automatically or upon command in response to an inquiry from a seeker 62.

The system of the invention stores a record of all communications from a seeker 62 in the stored emails database 68 which can be easily accessed by the host 63 as required.

The system of the invention also has a facility to enable the host 63 to send information about the host's 63 properties to other external holiday rentals listings websites 3 and publishes the information to social networks upon command via a published application programming interface. In an alternative embodiment, property details may be transmitted to other external holiday rentals listings websites 3 by the host 63 submitting the relevant login identification and password to the system of the invention. The system of the invention then mimics the login identification and password to external holiday rentals listing websites 3 to access the external websites 3 and transmit the host's property listings to the external websites 3. Similarly, updated or current calendars of property availability can be automatically posted by the system of the invention to the external websites 3.

Alternatively, updated calendars of property availability can be posted on external websites 3 using an Application Programming Interface.

The system of the invention is also provided with a payment module to facilitate the transmission of rental payments from the seeker 62 to the host 63.

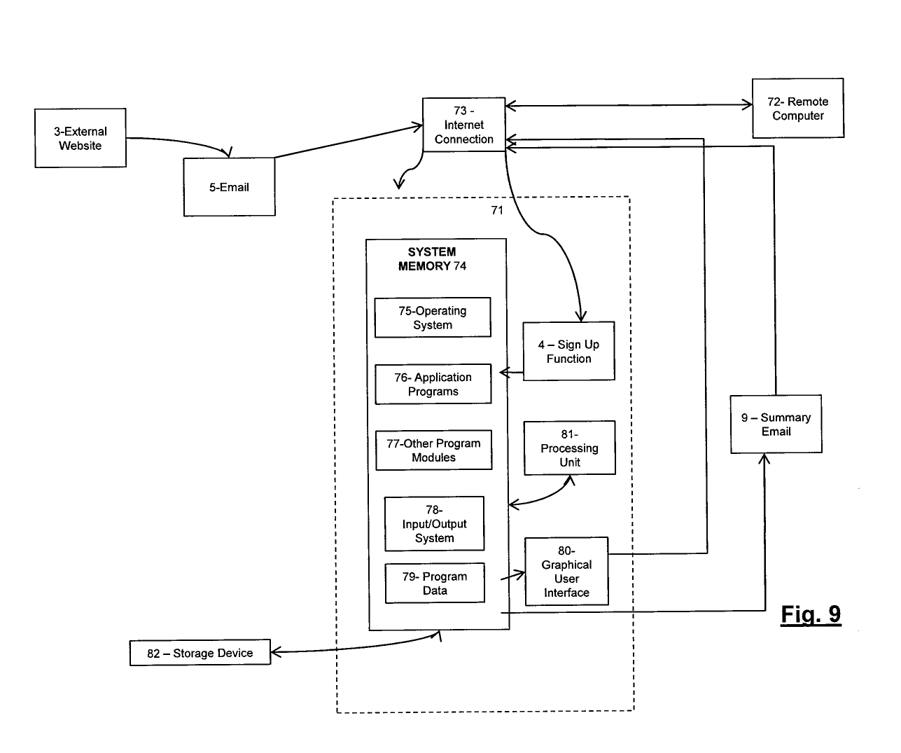

The system of the invention can be implemented on a variety of different computing platforms including but not limited to computers, mobile phones, slates, smart phones, laptops, netbooks and the like. As shown in FIG. 9, an exemplary system for implementing the invention is made up of a general purpose computing device in the form of a computer 71 in communication with a remote computer 72 to which a user has access via an internet connection 73. The system includes a system memory 74 incorporating an operating system 75, application programmes 76 and other programme modules 77 as required in accordance with the various embodiments of the invention. The system memory 74 can communicate with a processing unit 81 via a conventional communication system bus.

A graphical user interface 80, which can be a dashboard 10 as previously described, is also accessible to the remote computer 71 via the Internet connection 73 so that a user can access data in the system memory 74.

An input/output system 78 facilitates the transfer of information between elements within the computer 71. Programme code means made up of programme modules can be stored on a storage device 82 such as a hard disc, magnetic disc, optical disc, ROM, RAM or the like and can also include the operating system 75, application programmes 76, other programme modules 77 and programme data 79 as required.

The invention is not limited to the embodiments herein described which may be varied in construction and detail.

1. A method for sorting classes of email messages requested by a user, the method comprising:
receiving the user's email messages at an intermediate email address within an email sorting system;
parsing the received email messages to extract data from the emails;
storing the extracted data in an information database;
comparing the extracted data with stored data in the information database;
retrieving stored data from the information database relevant to the email message, and
autopopulating a record with the extracted data and the retrieved stored data.

2. A method as claimed in claim 1 further comprising summarizing the extracted data and the retrieved stored data and emailing the summarized extracted data and retrieved data to the user.

3. A method as claimed in claim 2 comprising displaying the extracted data and the stored data on a graphical user interface accessible to the user.

4. A method as claimed in claim 3 wherein the graphical user interface comprises a dashboard.

5. A method as claimed in claim 1 wherein the intermediate email address comprises a user-specific intermediate email address generated in response to the user signing up to the email sorting system.

6. A method as claimed in claim 5 comprising storing the user-specific intermediate email address in an intermediate email address database of the email sorting system.

7. A method as claimed in claim 1 wherein the intermediate email address comprises an email sorting system-specific intermediate email address peculiar to the class of email messages to be sorted by the email sorting system.

8. A method as claimed in claim 7 wherein the email message to be sorted is forwarded to the email sorting system-specific intermediate email address by the user.

9. A method as claimed in claim 8 further comprising generating a user-specific email address for the user upon receipt of the email message to be sorted.

10. A method as claimed in claim 1 wherein the class of email messages comprises coupon containing email messages from an external website subscribed to by the user.

11. A method as claimed in claim 10 wherein the information database comprises a database of coupon website source email addresses, a database of known deals and associated coupons and a database of coupons purchased by the user.

12. A method as claimed in claim 11 wherein the coupon containing email message address is compared with the database of coupon website source email addresses to identify the coupon containing email message.

13. A method as claimed in claim 11 further comprising continuously searching the Internet to locate new deals and associated coupons and storing a record of the new coupons in the database of known coupons.

14. A method as claimed in claim 11 wherein the coupon containing email message is matched with known coupons in the database of known coupons.

15. A method as claimed in claim 14 comprising reading characters from the coupon into memory, creating a coupon description from the characters, pattern matching the created coupon description with the database of known deals and associated coupons and creating a record of any matches in the purchased coupon database.

16. A method as claimed in claim 1 wherein the class of email messages comprises email messages between a vacation accommodation seeker and a vacation accommodation host or website.

17. A method as claimed in claim 16 wherein the information database comprises an email template database, a property database and a stored emails database.

18. A method as claimed in claim 1 wherein the class of email messages comprises email newsletters containing news digests.

19. A method as claimed in claim 18 wherein the information database comprises a source email address database and a user's email subscription database.

20. A method as claimed in claim 19 comprising parsing the received news digests, storing the news digests in the information database, extracting heading tags from the news digests, storing the heading tags in the information database with the news digests, identifying links to external websites in the email newsletters, storing the links to the external websites in the information database, crawling the external websites, extracting data from the crawled websites and storing the data extracted from the external websites in the information database and subjecting the stored data to a relevance algorithm to rank the data according to the user's preferences.

21. A method as claimed in claim 20 wherein the stored data subjected to the relevance algorithm comprises meta tags.

22. A method as claimed in claim 21 wherein the meta tag data comprises author generated meta tags.

23. A method as claimed in claim 21 wherein the relevance algorithm attributes a meta tag interest score to the meta tags in accordance with the user's interests.

24. A method as claimed in claim 23 further comprising normalising the meta tag interest score according to a time period and compensating the normalised meta tag interest score according to the frequency with which the user follows the link for a news digest to an external website.

25. A method as claimed in claim 20 wherein the user's preferences are automatically updated by the relevance algorithm according to usage by the user and the updated user's preferences are stored in a user preferences database.

26. A system for sorting classes of email messages requested by a user comprising:
means for receiving the user's email messages at an intermediate email address within an email sorting system;
an email parser for parsing the received email messages to extract data from the emails;
an information database for storing the extracted data;
means for comparing the extracted data with stored data in the information database;
means for retrieving stored data from the information database relevant to the email message, and
means for autopopulating a record with the extracted data and the retrieved stored data.

27. A system as claimed in claim 26 further comprising a graphical user interface for displaying the autopopulated record for the user.

28. A system as claimed in claim 27 wherein the graphical user interface comprises a dashboard.

29. A system as claimed in claim 27 further comprising an information summariser for summarising the information.

30. A system as claimed in claim 27 further comprising means for continuously determining the user's information preferences to autopopulate the record in accordance with the user's preferences.

31. A computer program product comprising computer executable instructions for performing a method of sorting classes of email messages requested by a user, the method comprising:
receiving the user's email messages at an intermediate email address within an email sorting system;
parsing the received email messages to extract data from the emails;
storing the extracted data in an information database;
comparing the extracted data with stored data in the information database;
retrieving stored data from the information database relevant to the email message, and
autopopulating a record with the extracted data and the retrieved stored data.
